(19) United States
(12) Patent Application Publication
(10) Pub. No.: US 2009/0026064 A1
(43) Pub. Date: Jan. 29, 2009

(54) PRECIPITATION OF SILICA IN A BAYER PROCESS

(75) Inventors: Linda Jane McCausland, West Lafayette, IN (US); Martin Fennell, Clare (IE)

Correspondence Address: LAW OFFICES OF WILLIAM H. HOLT, 12311 HARBOR DRIVE, WOODBRIDGE, VA, 22192, US

(73) Assignee: ACCENTUS PLC, London (GB)

(21) Appl. No.: 11/571,688

(22) PCT Filed: Jun. 23, 2005
(86) PCT No.: PCT/GB05/50097

§ 371 Date: Feb. 19, 2008

(30) Foreign Application Priority Data
Jul. 7, 2004 (GB) 0415227.8

(51) Int. Cl. B01J 19/10

(52) U.S. Cl. 204/157.42; 422/128

(57) ABSTRACT

In the Bayer process for the production of alumina, problems are caused by silica dissolving in the caustic liquor. This silica arises from the presence of kaolin in the bauxite. A process for removing this kaolin comprises contacting the bauxite with sodium hydroxide solution to form a mixture, and subjecting the mixture to intense ultrasonic irradiation to cause cavitation; this can be carried out at temperatures below 100° C. This enhances both the dissolution of kaolin and the precipitation of sodium aluminium silicate. Silica remaining in solution in spent Bayer liquor (after digestion and then precipitation of gibbsite) can be removed by a similar ultrasonic irradiation treatment to cause it to precipitate before it forms scale in heat exchangers.

This invention relates to a process and apparatus for precipitating silica in the course of a Bayer process for the production of alumina.

The Bayer process is a widely used process for obtaining pure alumina from bauxite ore. It involves treating the ore with hot sodium hydroxide solution, so alumina dissolves to form sodium aluminate, leaving other minerals from the ore in the form of red mud. If the alumina in the bauxite is primarily gibbsite, this dissolution step is typically carried out in the range 100° C. to 150° C., while if it is primarily boehmite or diaspore then higher temperatures such as 200° C. to 300° C. are used. The saturated sodium aluminate solution is cooled, and seeded with aluminium trihydroxide crystals, Al(OH)₃, i.e. gibbsite. The alumina in solution precipitates as gibbsite, and can then be calcined at say 1050° C. to form pure alumina. The remaining solution, which may be referred to as spent Bayer liquor, can be recycled to treat fresh ore, after addition of any necessary sodium hydroxide to ensure it is concentrated enough.

Gomes, in BR 9701866-0, has suggested use of ultrasound to enhance the dissolution of alumina from bauxite (in a digester at 150° C.), and also the use of ultrasound to enhance the sedimentation of the resultant mud. No details are given as to how this may be achieved.

The conventional Bayer process enables pure alumina to be separated from impurities such as compounds of iron or titanium, which remain insoluble, but is not entirely satisfactory in separating some silica-containing impurities. Silica is typically present either as quartz or kaolin. Quartz does not readily dissolve in the caustic liquor, but kaolin, which is a compound in which silica is combined with alumina, does dissolve. Indeed, kaolin in this context refers to any silica mineral that will react with the caustic liquor at temperatures below about 120° C.; such kaolin is present as very fine particles (typically in the range about 30 nm up to 600 nm) and is intimately mixed with the alumina minerals, particularly gibbsite. Silica in solution causes significant problems, in particular the consumption of caustic soda in bringing about its precipitation, which is a particular problem with high-silica bauxite; and scaling of plant surfaces due to its precipitation, which is a particular problem with lower-silica bauxite.

The level of silica can be controlled, for example, by a pre-desilication step prior to the dissolution of alumina, by combining the ore with a small quantity of caustic soda at a temperature of around 100° C., so that kaolin first goes into solution:

Al₂O₃.2SiO₂+NaOH→Na₂SiO₃

and is then removed by precipitation to form an insoluble sodium aluminium silicate (similar to carnegieite or nepheline), which will then form a component of the red mud:

Na₂SiO₃+NaAlO₂→Na₂O.Al₂O₃.2SiO₂ (or 2 NaAlSiO₄)

Sufficient kaolin must dissolve to cause supersaturation, so that silicate crystals form and act as a seed to precipitate more silicate. The rate of precipitation is found to increase with temperature, however even at 135-150° C. it occurs much more slowly than alumina dissolution. The need for desilication therefore means that the material must be held at this digestion temperature for a prolonged period which is typically between 30 minutes and 12 hours.

Since both the dissolution and precipitation steps in such a pre-desilication operation are comparatively slow, large volume storage tanks are typically employed.

According to the present invention there is provided a process for removing kaolin from bauxite as part of a Bayer process, the process comprising contacting the bauxite with a sodium hydroxide solution to form a mixture at a temperature below that at which alumina is dissolved, and subjecting the mixture at such a temperature to intense ultrasonic irradiation to cause cavitation, so as to enhance both the dissolution of kaolin and the precipitation of sodium aluminium silicate.

Surprisingly the ultrasonic irradiation has been found to enhance both the dissolution process and the precipitation process, and to enable these processes to be performed at a lower temperature than has hitherto been feasible. For example the mixture may be held at a temperature in the range 30° to 110° C., more preferably in the range 35° to 75° C. Furthermore both processes take place more rapidly, so that it is not necessary to store the mixture for as long a period, and the necessary volume of storage tanks is therefore reduced.

This process may be the first stage of alumina digestion or dissolution, utilising the same sodium hydroxide solution as is subsequently used for dissolution of alumina; alternatively, this process may be a pretreatment stage, and additional sodium hydroxide solution would be added subsequently for the digestion or dissolution stage. In either case the sodium hydroxide solution is preferably spent Bayer liquor, at least in part, as this already contains aluminate ions in solution.

Preferably a stream of the mixture is subjected to ultrasonic irradiation by causing the stream to flow through a duct, and continuously subjecting the contents of the duct to ultrasonic irradiation, for example a recirculation duct connected to a storage tank. The ultrasound may be applied using a multiplicity of ultrasonic transducers attached to a wall of the duct in an array of separate transducers extending both circumferentially and longitudinally, each transducer being connected to a signal generator so that the transducer radiates no more than 3 W/cm², the transducers being sufficiently close together and the number of transducers being sufficiently high that the power dissipation within the vessel is between 25 and 150 W/litre. Preferably the duct is of width at least 0.10 m, that is to say if the duct is cylindrical it is of diameter at least 0.10 m. The values of power given here are those of the electrical power delivered to the transducers, as this is relatively easy to determine. Such an irradiation vessel is described in WO 00/35579. With such a vessel there is little or no cavitation at the surface of the wall, so that there is no erosion of the wall and consequently no formation of small particles of metal.

Preferably the ultrasound is supplied by a multiplicity of transducers coupled to the wall of a pipe carrying the mixture, the mixture flowing at such a rate that it is insonated for a few seconds (say between 1 s and 6 s) on each pass through the pipe. Alternatively the ultrasound may be supplied intermittently, as a sequence of pulses, for example a pulse of between 1 and 4 seconds at intervals of between 10 s and 120 s. Such pulsed operation of the transducers may be combined with a slower flow rate through the pipe.

The Bayer process then involves dissolution of alumina, the separation of the insoluble impurities as red mud, and the seeded precipitation of gibbsite. The remaining Bayer liquor may be saturated with silica, and typically is supersaturated, but the crystallisation has slow kinetics. When such spent liquor is reheated for reuse, the kinetics of this crystallisation process increase, so that silica tends to come out of solution (in the form of a sodium aluminium silicate) and can cause scaling problems. Accordingly the present invention also provides that such spent liquor should be similarly subjected to intense ultrasonic irradiation to promote this crystallisation, prior to being reheated.

The invention also provides an apparatus for performing this method.

The invention will now be further and more particularly described by way of example only and with reference to the accompanying drawing, which shows a flow diagram of plant for obtaining gibbsite from bauxite.

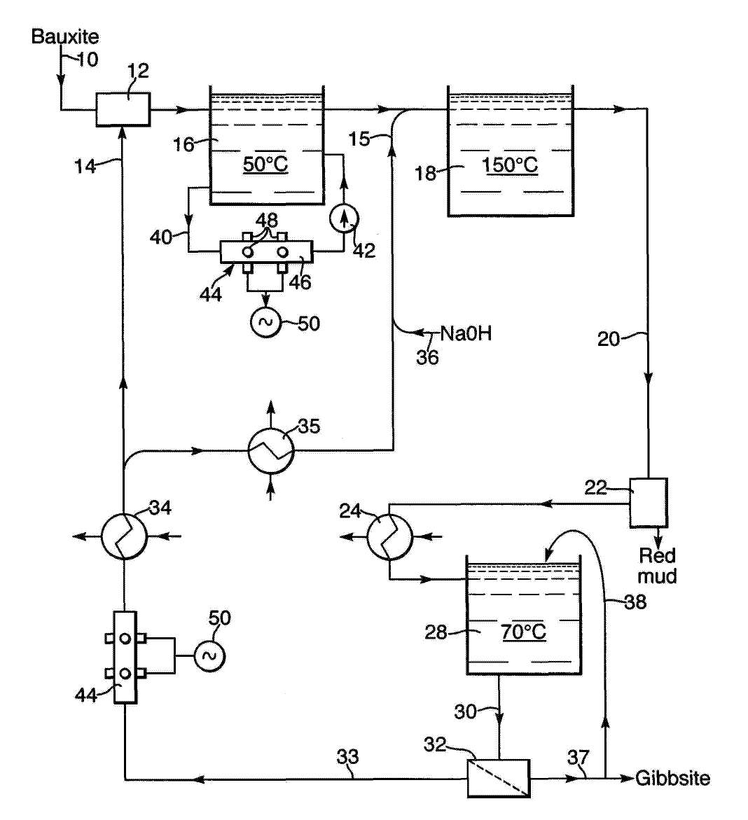

Referring to FIG. 1, a bauxite ore 10 which contains a high proportion of gibbsite but also contains impurities including kaolin is first fed into a grinder 12 in which it is ground and mixed with spent Bayer liquor supplied through a line 14, the resulting slurry being fed into a pre-desilication storage tank 16 held at a temperature of 50° C. After 30 minutes the resulting slurry is mixed with additional spent Bayer liquor (this being a caustic solution of between 4 M and 5 M sodium hydroxide) fed through a line 15 at a temperature of about 150° C., and is digested in a tank 18 held at this temperature. This produces a caustic solution 20 containing sodium aluminate, which may be referred to as a Bayer liquor. This liquor 20 is separated from the associated red mud by a settler 22. The Bayer liquor 20 is cooled, through heat exchangers 24 (for example ending up at 70° C.), so that the resulting liquor 26 is significantly supersaturated at least as regards aluminium trihydroxide (gibbsite). The liquor 26 is then supplied to a hold-up tank 28 in which gibbsite precipitates. A product slurry 30 comprising precipitated gibbsite and spent Bayer liquor is tapped off from the base of the tank 28 and is supplied to a solids separation unit 32 such as a belt filter or a sedimentation tank, and the liquor 33 (which consists of caustic soda and also sodium aluminate) is returned to the process to provide the streams 14 and 15, for example through heat exchangers 34 and 35. Additional sodium hydroxide may be added to the stream 15 through a line 36 to ensure that the concentration remains sufficiently high. The filter cake 37 of gibbsite crystals is partly removed as the desired product, and the remainder 38 is used as seed for the precipitation process.

Although only one pre-desilication tank 16 is shown, it will be appreciated that there may be several such tanks 16 used successively, so that the grinder 12 can feed slurry continuously into one or other of these storage tanks 16 in succession, and that the residence time of slurry in each tank 16 is for example 6 hours. Similarly, there may be several such digester tanks 18.

Each pre-desilication tank 16 is provided with a 5 recirculation loop 40 comprising a pump 42 and an ultrasonic irradiation module 44. The loop 40 is shown diagrammatically, and the flow path may typically be of nominally six inch (150 mm) diameter pipe, and the ultrasonic irradiation module 44 may comprise a stainless-steel duct 46 of the same internal diameter.

The ultrasonic module 44 includes ten transducer modules 48 in a regular array attached to the outside of the duct 46. Each transducer module 48 comprises a 50 W piezoelectric transducer which resonates at 20 kHz, attached to a conically flared aluminium coupling block by which it is connected to the duct wall, the wider end of each block being of diameter 63 mm. The transducer modules 48 are arranged in two circumferential rings each of five modules 48, the centres of the coupling blocks being about 105 mm apart around the circumference, and about 114 mm apart in the longitudinal direction. A signal generator 50 drives all the transducer modules 48.

With this ultrasonic module 44 the power intensity is only about 1.6 W/cm², and is such that cavitation does not occur at the surface of the wall, so erosion of the surface does not occur. Nevertheless the power density is sufficient to ensure nucleation in the slurry. The volume of slurry which is subjected to insonation is about 5 l, so the power density is about 100 W/litre. (The power density can be adjusted by adjusting the power supplied to the transducer modules 48, but is usually between 40 and 100 W/litre.)

The effect of this ultrasonic treatment is to enhance the rate at which kaolin dissolves in the spent Bayer liquor, and at the same time to enhance the rate at which sodium aluminium silicate precipitates as an insoluble material. Consequently the length of time that the slurry has to remain in the pre-desilication tank 16 is decreased. Hence, in the plant shown in FIG. 1, for a given rate of processing of bauxite ore, fewer such tanks 16 are required.

The flow rate through the ultrasonic treatment loop 40, and so through the duct 46, should be such that the slurry is insonated for a period between 1 s and 10 s, for example about 3 s. A larger quantity of liquor can be treated (per unit time), by using a longer irradiation duct of the same diameter, with more circumferential rings of five modules 38 each, the rings being spaced apart by 114 mm centre to centre in the longitudinal direction, as described in relation to the drawing. For example, using a duct with twenty such circumferential rings of five modules 48, and so with an insonation volume about ten times that of the duct shown in the drawing, the same insonation time can be achieved with a ten times increase in flow rate.

Alternatively the ultrasound may be supplied intermittently, as a sequence of pulses, for example the generator 50 may be energised intermittently to drive all the transducer modules 48 in the apparatus as shown, so as to generate a sequence of pulses of intense ultrasound within the duct 46. For example there might be a pulse of duration 2 s at intervals of 20 s. This may be combined with a reduced flow rate around the recirculation loop 40. This pulsed operation provides time for crystal growth between successive pulses, and so may lead to the formation of larger particles of sodium aluminium silicate.

The filtrate 33 of spent Bayer liquor emerging from the filter unit 32 contains not only sodium hydroxide and sodium aluminate, but may also be supersaturated with silica compounds. The crystallisation of these silicates has slow kinetics, and so they do not come out of solution. However, as the liquor is passed through the heat exchanger 35 to raise its temperature back to 150° C. or more, the kinetics becomes faster, so that there is a tendency for the heat exchanger surfaces to become fouled with silicate deposits. This is prevented by passing the filtrate 33 through another ultrasonic module 44 before it reaches the first heat exchanger 34. On its passage through this ultrasonic module 44 the crystallisation of the complex silicate is initiated, so that the complex silicates are already in particulate form by the time that they pass through the heat exchanger 35. This ensures that fouling of the heat exchanger surfaces does not occur. The particulate silicates, being insoluble, will emerge with the red mud from the settler 22.

It will be appreciated that the plant shown in the figure may be modified in various ways while remaining within the scope of the invention. For example ultrasonic transducers may be attached directly to the wall of the tank 16, rather than being provided in a recirculation duct.

1. A pre-desilication process for removing kaolin from bauxite as part of a Bayer process, said process comprising the steps of contacting said bauxite with a sodium hydroxide solution for forming a mixture at a temperature below that at which alumina is dissolved, said mixture being held at a temperature in the range 35° to 75° C., and subjecting said mixture at such a temperature to intense ultrasonic irradiation to cause cavitation for enhancing both the dissolution of kaolin and the precipitation of sodium aluminium silicate, said process being performed for no more than 6 hours.

2. A pre-desilication process as claimed in claim 1 wherein said process is performed for 30 minutes.

3. A pre-desilication process as claimed in claim 1 wherein said mixture is subjected to intense ultrasonic irradiation while being circulated through a recirculation loop.

4. A pre-desilication process as claimed in claim 1 in which said mixture contains the same sodium hydroxide solution as is subsequently used for dissolution of alumina.

5. A pre-desilication process as claimed in claim 1 wherein additional sodium hydroxide solution is subsequently added to said mixture for the digestion stage.

6. A pre-desilication process as claimed in claim 1 in which said sodium hydroxide solution in said mixture comprises spent Bayer liquor.

7. A Bayer process incorporating a pre-desilication process as claimed in claim 1 wherein spent liquor from the Bayer process is subjected to intense ultrasonic irradiation for promoting crystallisation of silicates prior to being reheated.

8. A Bayer process plant incorporating a device for removing kaolin, said device operating in accordance with a pre-desilication process as claimed in claim 1.

9. A Bayer process plant as claimed in claim 8 wherein the ultrasound is applied using a multiplicity of ultrasonic transducers attached to a wall of a duct in an array of separate transducers extending both circumferentially and longitudinally, each transducer being connected to a signal generator so that the transducer radiates no more than 3 W/cm², the transducers being sufficiently close together and the number of transducers being sufficiently high that the power dissipation within the vessel is between 25 and 150 W/litre.
